(19) United States
(12) Patent Application Publication
(10) Pub. No.: US 2014/0207394 A1
(43) Pub. Date: Jul. 24, 2014

(54) SYSTEMS AND METHODS FOR COMMUNICATING WITH HEATING, VENTILATION AND AIR CONDITIONING EQUIPMENT

(71) Applicant: JB Industries, Inc., (unknown)

(72) Inventors: David Madden, Aurora, IL (US); Scott Randall, Jupitor, FL (US)

(21) Appl. No.: 14/162,709

(22) Filed: Jan. 23, 2014

Related U.S. Application Data
(60) Provisional application No. 61/755,921, filed on Jan. 23, 2013.

(51) Int. Cl. G01M 99/00

(52) U.S. Cl. CPC G01M 99/005
USPC 702/50; 236/51; 702/188; 702/130

(57) ABSTRACT

Systems and methods for wireless diagnostic equipment. HVAC equipment is configured with wireless technologies that are enabled to communicate diagnostic data with a wireless communications device, such as a smart phone, tablet, laptop or other wireless communications device. Software on the wireless communications device is enabled to receive the diagnostic data and to perform various operations based on the diagnostic data and other data at the wireless communications device. Furthermore, the software is enabled to remotely configure and operated the HVAC equipment.

### TECHNICAL FIELD

The disclosed technology generally relates to heating, ventilation, and air conditioning (HVAC) equipment and, more specifically, relates to manifold and vacuum gauge technology enabled with wireless telecommunication components for communicating diagnostic data.

### BACKGROUND

HVAC technicians locally monitor modern HVAC equipment to ensure safe and proper operation. Once initiated, however, some tests do not require the technician's constant attention. Furthermore, some diagnostic systems (e.g., HVAC systems) require long operating times before a measurable objective is achieved, such as a compressor reaching a desirable temperature and or pressure level. The technician, however, often cannot leave the proximity of the test equipment until the measuring procedure is completed. The inefficient use of the technician's time while waiting for the completion (or an updated status) of a HVAC-related procedure can affect the technician's ability to start and or maintain other procedures.

### BRIEF DESCRIPTION OF THE DRAWINGS

FIG. 1 is a block diagram of a wireless digital vacuum system.

FIG. 2 is a block diagram illustrating external features of a digital vacuum gauge in which aspects of the described technology may operate in a networked computer environment.

FIG. 3 is a block diagram illustrating internal features of a digital vacuum gauge in which aspects of the described technology may operate in a networked computer environment.

FIG. 4 is a block diagram of a wireless digital manifold system.

FIG. 5 is a block diagram illustrating external features of a digital manifold in which aspects of the described technology may operate in a networked computer environment.

FIG. 6 is a block diagram illustrating internal features of a digital manifold in which aspects of the described technology may operate in a networked computer environment.

FIG. 7 is a flow diagram illustrating different operational modes of a digital vacuum gauge and a digital manifold.

Note: the headings provided herein are for convenience and do not necessarily affect the scope or interpretation of the described technology.

### DETAILED DESCRIPTION

The inventors have recognized that current technology has failed to provide efficient HVAC diagnostic equipment that requires little oversight when operating. Currently, technicians often have to wait extended periods of time for a process to end or to indicate its progression. For example, evacuating an automobile compressor can require different and multiple types of HVAC equipment, each of which may require calibrating and monitoring to ensure proper and safe operation. An HVAC vacuum, for example, removes moisture from the compressor by evacuating atmospheric pressure. To ensure that the HVAC vacuum is in optimal condition, a vacuum gauge is used to test the HVAC vacuum. A manifold allows a technician to measure a HVAC system to ensure that the system is properly evacuated by the vacuum and dehydrated of air and moisture before being charged. These and other procedures can take up to an hour or more and require the technician to manually monitor the vacuum and manifold gauges, for example. This is a lost opportunity for the technician to perform other tasks.

In some embodiments, the described technology is HVAC equipment configured with networking components for sending and receiving wireless messages to and from a near and or remote device where the messages are displayed. Wireless-enabled HVAC (“WHVAC”) equipment can send one or several messages to a wireless device using multiple different technologies, such as near-field technologies (e.g., Bluetooth, 802.11 standards) and remote technologies (e.g., Cellular, GPRS, LTE). In some embodiments, both local and or remote wireless (or wired) technologies are used based on how the WHVAC is configured.

In some embodiments, a wireless device communicates with the WHVAC equipment. In one embodiment, the wireless device (e.g., a smart phone, tablet, laptop, computer) is configured with one or more near or far field wireless components (e.g., Bluetooth, Wi-Fi, Cellular/LTE/GPS) that receive one or more messages from one or more WHVAC devices. A message can indicate the current status of the equipment (a measurement of time, temperature, pressure, etc.), initiate an operation, or provide raw data, among other things. The wireless device can process the message for determining additional information, such as a historical timeline, a summary, conversion information, alarm status, billing information, etc.

In one or more embodiments, a wireless device sends messages to WHVAC equipment to change its operation state or other characteristics, such as controlling power, updating how the WHVAC reports data (e.g., in microns, Pascals, mBars), calibrating sensors, setting timers, executing user programs, etc.

In some embodiments, the described technology is a wireless WHVAC system that automatically determines how and when a WHVAC device communicates with the wireless (or a wired) device. For example, the described technology can detect whether an HVAC system includes a wireless component, whether the wireless component is operational, and can determine which of multiple wireless components (e.g., a Bluetooth radio or a cellular radio) in a single WHVAC should communicate wireless messages, for example.

The described technology can be implemented as hardware and/or software implemented on, and executed by, a processor. The described technology can include a thin-client component, such as an application on a smart phone that can implement, for example, a user interface to allow technicians to control HVAC operations.

Various embodiments of the technology will now be described. The following description provides specific details for a thorough understanding and enabling description of these embodiments. One skilled in the art will understand, however, that the described technology may be practiced without many of these details. Additionally, some well-known structures or functions may not be shown or described in detail so as to avoid unnecessarily obscuring the relevant description of the various embodiments.

The terminology used in the description presented below is intended to be interpreted in its broadest reasonable manner, even though it is being used in conjunction with a detailed description of certain specific embodiments of the technology. Certain terms may even be emphasized below; however, any terminology intended to be interpreted in any restricted manner will be overtly and specifically defined as such in this Detailed Description section.

The following discussion provides a brief, general description of a suitable computing environment in which aspects of the described technology can be implemented. Although not required, aspects of the technology may be described herein in the general context of computer-executable instructions, such as routines executed by a general or special purpose data processing device (e.g., HVAC equipment, a server or client computer). Aspects of the technology described herein may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data related to the technology may be distributed over the Internet or over other networks (including wireless networks) on a propagated signal on a propagation medium (e.g., an electromagnetic wave(s), a sound wave) over a period of time. In some implementations, the data may be provided on any analog or digital network (packet switched, circuit switched, or other scheme).

The described technology can also be practiced in distributed computing environments where tasks or components are performed by remote processing devices, which are linked through a communications network, such as a local area network (“LAN”), wide area network (“WAN”), or the Internet. In a distributed computing environment, program components or sub-routines may be located in both local and remote memory storage devices. Those skilled in the relevant art will recognize that portions of the described technology may reside on a server computer while corresponding portions reside on a client computer. Data structures and transmission of data particular to aspects of the technology are also encompassed within the scope of the described technology.

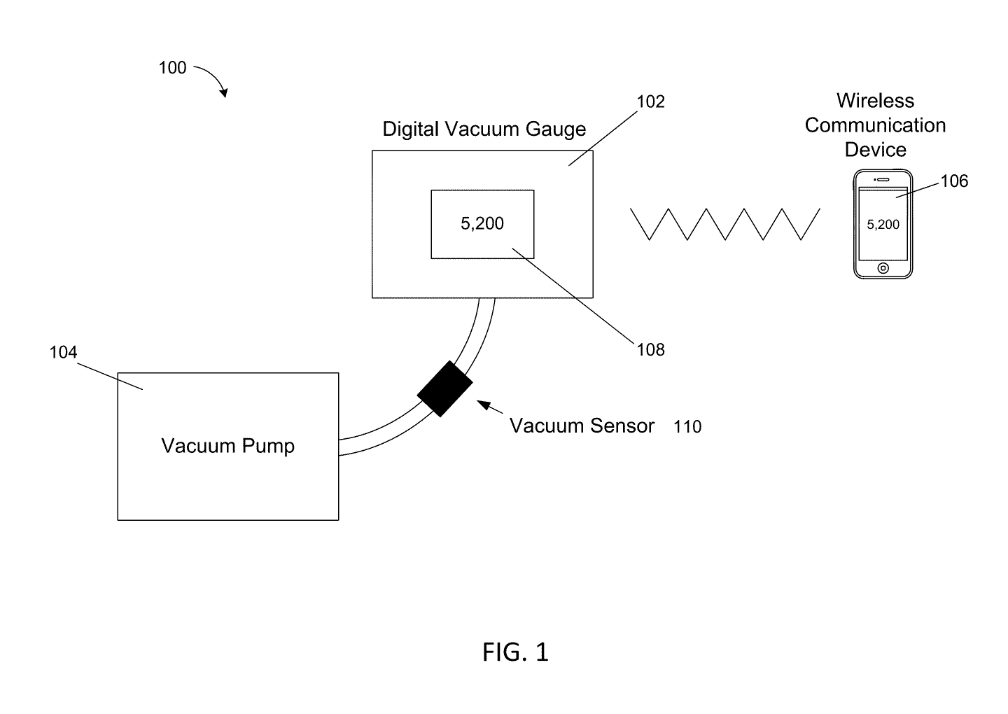

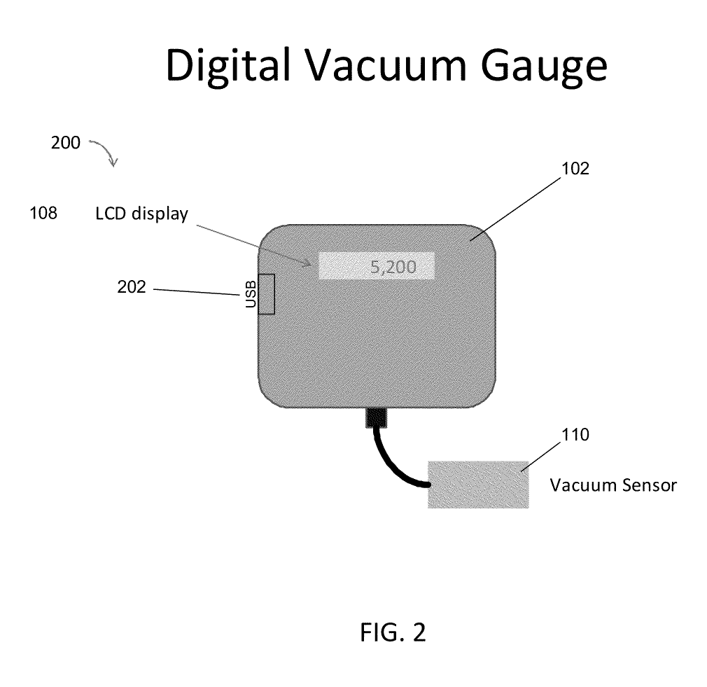

Referring to FIG. 1, in some embodiments, the described technology is a digital vacuum gauge that wirelessly communicates vacuum pressure (e.g., 5,200 mBars), as determined by a vacuum sensor, to a wireless communication device, such as smartphone, tablet, notebook, or other mobile computer device. As illustrated in FIG. 2, the vacuum gauge has external features, such as a cable attached to the vacuum sensor. The vacuum sensor is attached to the vacuum pump, as illustrated in FIG. 1, for measuring the vacuum pump's pressure. The digital vacuum gauge includes a display for indicating the vacuum pump's pressure (e.g., 5,200 mBars) and an external network and or bus interface (e.g., USB, Firewire, MIPI-based, serial RJ-11/RJ-45) to communicate data with a wired communication device, such as a server or personal computer.

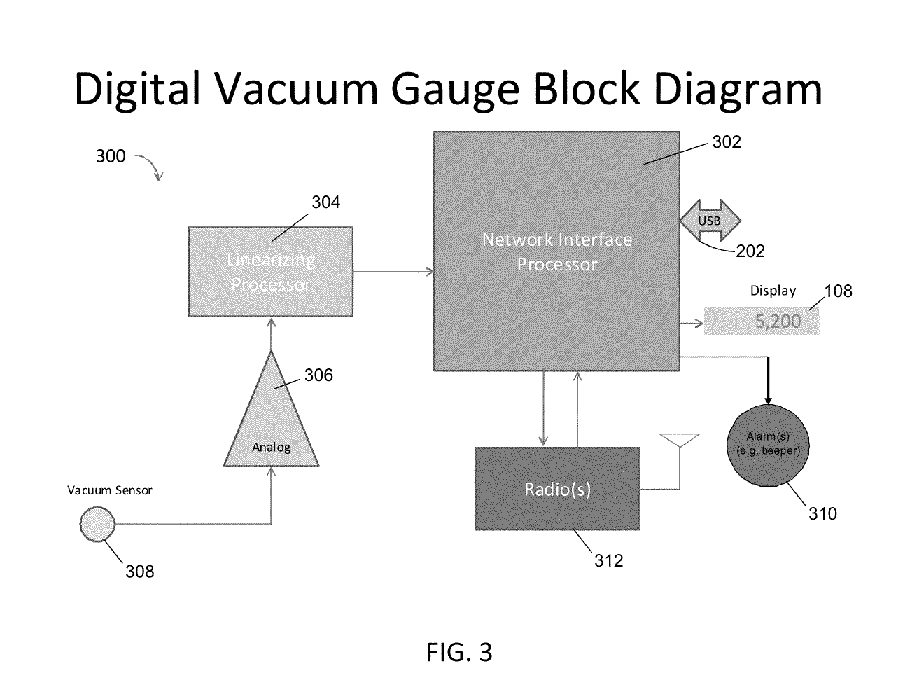

FIG. 3 is a block diagram illustrating internal components of a digital vacuum gauge. In particular, FIG. 3 illustrates a network interface processor configured to communicate with one or more radios, alarm(s), processor(s), the display and the external network and or bus interface, as depicted in FIG. 2. Pressure detected by the vacuum sensor is converted from an analog signal into a digital signal by a linear processor (e.g., an ARM Cortex processor executing instructions from an operating system). The network interface processor receives the digital signal and enables it for display at the digital display (e.g., an LCD or LED). Additionally or alternatively, the network interface processor enables the communication of the digital signal, via one or more radios, to the wireless communication device in FIG. 1. The one or more radios are, in some embodiments, short-range (e.g., Bluetooth, Wi-Fi) and or long-range (e.g., cellular/3G/LTE, satellite, WiMax) radios, however, various radio ranges and technologies are contemplated by the inventors. An application (e.g., an Android and or iPhone-based “app”) at the receiving wireless communication device can perform a variety of features, such as unit conversion (e.g., converting between microns, PSIA, INHG, Pascals, TORR, MTORR and MBAR), configuring alarms (e.g., audible and or visual indications that a level of pressure is reached), data logging, reporting, billing, control features of the digital vacuum gauge (e.g., power control and field calibration,) and other features such as creating user-customized profiles for automatically and or manually performing one or more of the above, or other, aspects of the described technology.

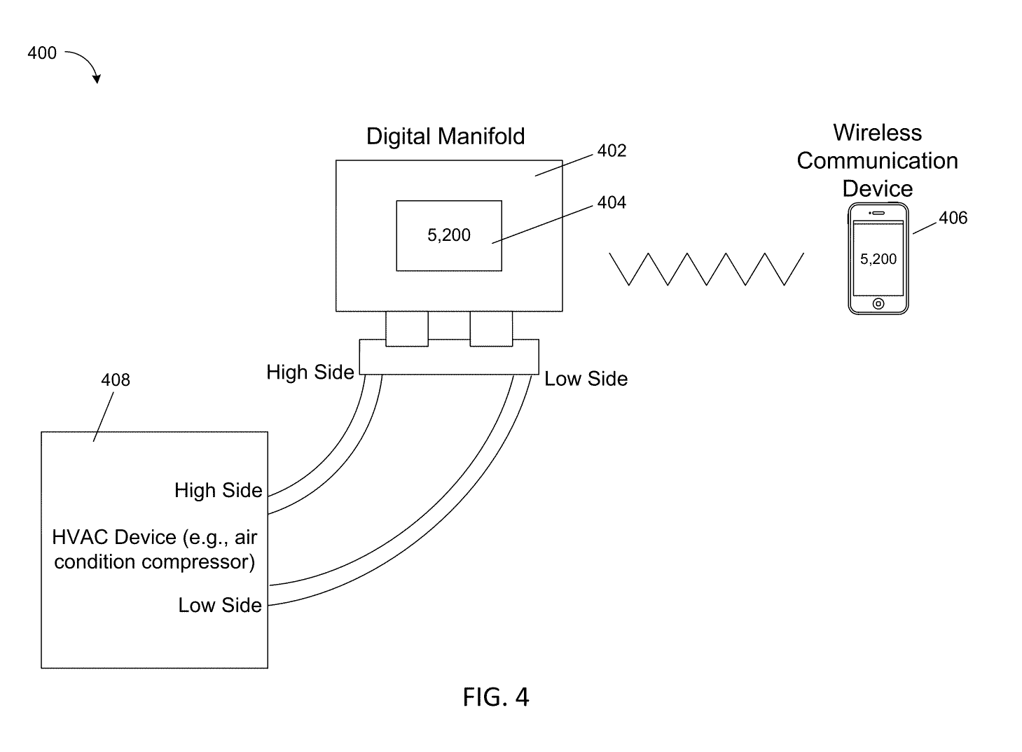

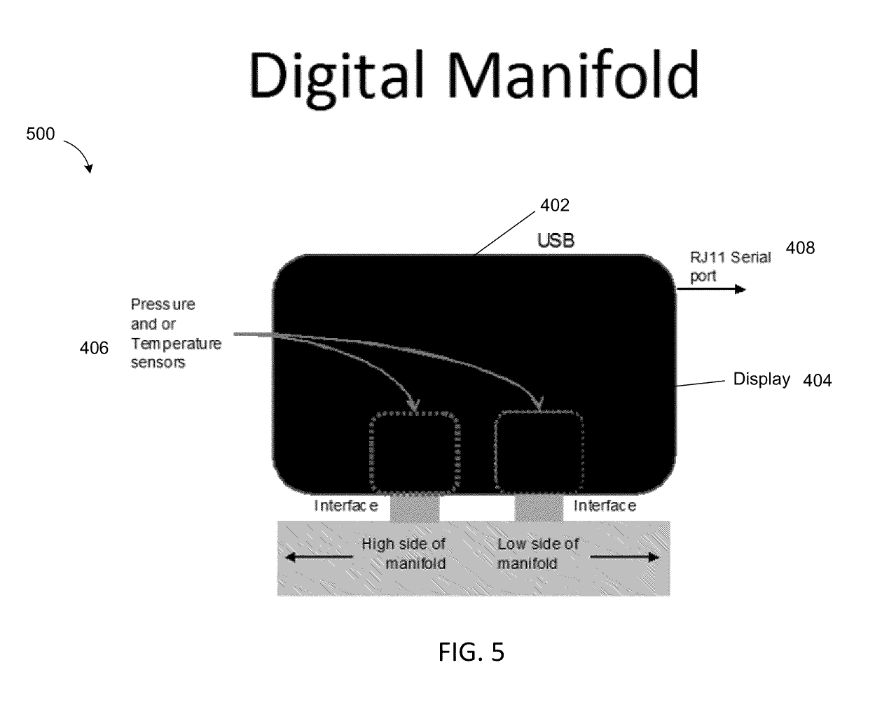

FIG. 4, in some embodiments, is a digital manifold that wirelessly communicates data (e.g., temperature and or pressure) with a wireless communication device, such as the wireless communication device described for FIG. 1. The digital manifold has two interfaces, a high-side and a low-side, that are configured to couple, via cables/tubes, to a respective high-side and low-side of a HVAC device (e.g., air conditioning device), as is known in the art. As illustrated in FIG. 5, the digital manifold has external features, such as the two interfaces for coupling the digital manifold to the HVAC device; a display for indicating temperature; pressure and or vacuum readings; and an external network and or bus interface (e.g., USB, Firewire, MIPI-based, serial, RJ-11/RJ-45) to communicate data with a wired communication device.

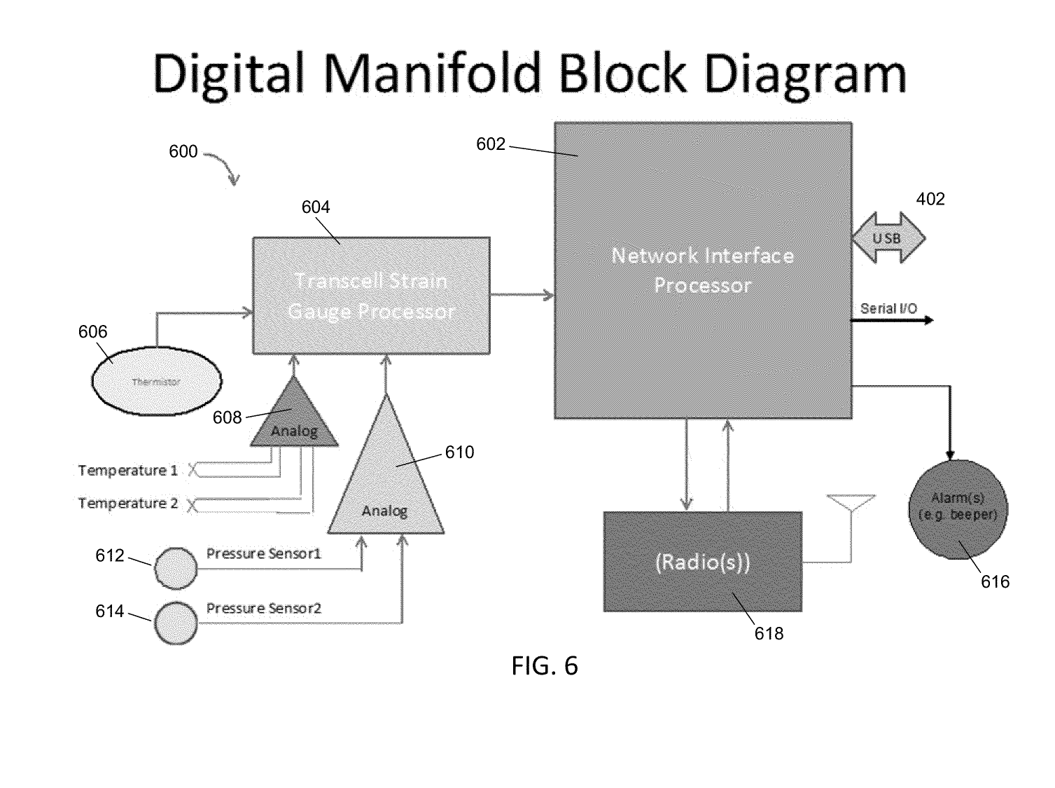

FIG. 6 is a block diagram illustrating internal components of a digital manifold. In particular, FIG. 6 illustrates a network interface processor configured to communicate with one or more radios, alarm(s), processor(s), the display, and the external network and or bus interface, as depicted in FIG. 5. Analog pressure is detected by pressure sensor 1 and pressure sensor 2 and converted into digital signals by a strain gauge processor, for example. Temperature sensor 1 and temperature sensor 2 detect fluid temperature in the tubes and convert the temperature from analog signals into digital signals by a thermistor coupled to the strain gauge processor, as is known in the art. The pressure and or temperature-based digital signals are processed by the network interface processor into a form suitable for display at the digital manifold, transmission by wired-based communication (e.g., via USB and or serial interfaces), and or transmission by wireless communication via the one or more radios. The one or more radios are, in some embodiments, short-range (e.g., Bluetooth, Wi-Fi) and or long-range (e.g., cellular/3G/LTE, satellite, WiMax) radios, however, various radio ranges and technologies are contemplated by the inventors. An application at the wireless communication device can perform a variety of features, such as converting units (e.g., converting to/from microns), configuring alarms (e.g., a visual and/or audible indication when a temperature and or level of pressure is reached), logging data, reporting, billing, measuring fluid weight, updating refrigerant tables, and controlling features, as well as other features such as user-customized profiles for automatically or manually performing one or more of the above, or other, aspects of the described technology.

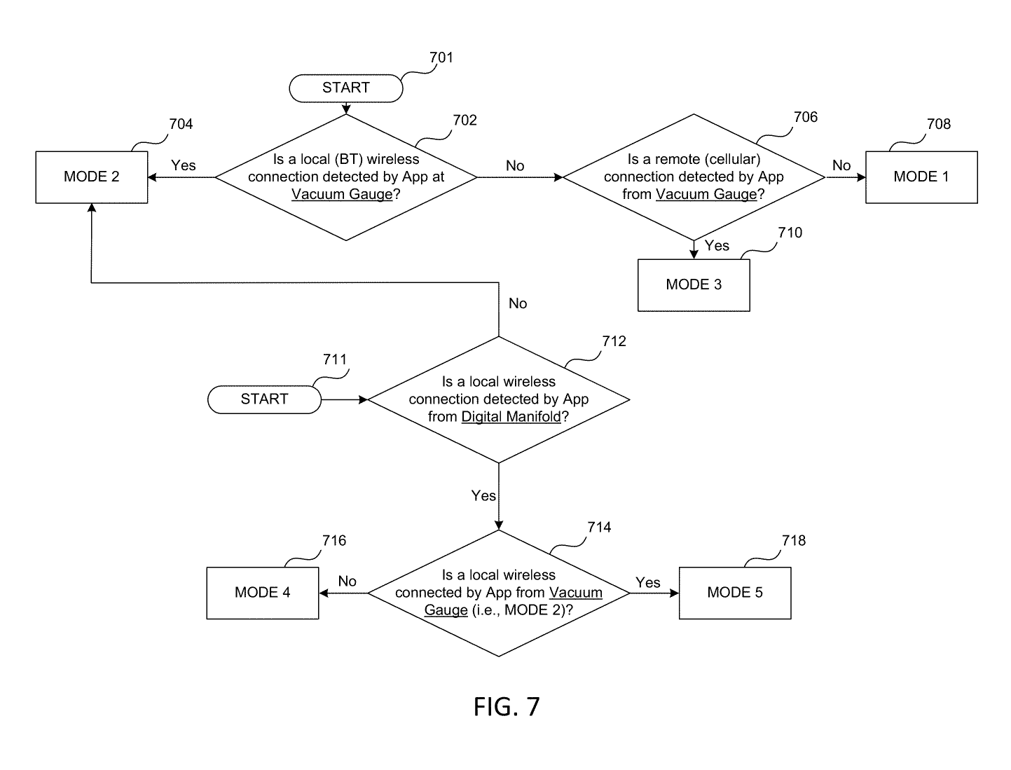

FIG. 7 is a flow diagram illustrating various operating modes of the digital vacuum gauge and or the digital manifold, based on the availability of one or more radios described in FIG. 3 and FIG. 6. Referring to FIG. 7, if the digital vacuum gauge has neither a short-range (e.g., Bluetooth) radio connection, at step 702, or a long-range (e.g., cellular) radio connection, at step 706, the digital vacuum will operate in a first mode where data is displayed at the digital vacuum. However if, at step 702, a short-range wireless connection is available from the vacuum gauge to the wireless communication device, the digital vacuum gauge will operate in a second mode in which, in some embodiments, sends messages to an app that performs various operations, such as unit conversions and remote control of the digital vacuum gauge, as mentioned above. If, at step 706, the presence of a cellular modem is detected at the vacuum gauge, the digital vacuum gauge sends messages for processing to a cellular enabled wireless device. The cellular enabled wireless device is, in some embodiments, coupled to a web server used by a technician to operate the digital vacuum gauge.

Referring to step 711, if, at step 712, the digital manifold has a short range radio and, at step 714 the digital vacuum gauge does not have a short range radio, the digital manifold operates in a fourth mode. In the fourth mode, the digital manifold communicates, via short-range (e.g., Bluetooth) radios, to an app. If, at step 714, the vacuum gauge has a short-range communication radio, each of the digital vacuum gauge and the digital manifold independently establish short-range communications to the app.

Other combinations of the above (and other modes) are contemplated by the inventors. For example, in a sixth operating mode (not shown), a digital manifold having both a short-range radio (e.g., Bluetooth) and a long-range radio (e.g., cellular) operates as a gateway for a digital vacuum gauge having only a short-range radio (e.g. Bluetooth). The vacuum gauge sends data to the short-range radio at the digital manifold, for example via Bluetooth. The digital manifold aggregates, in some embodiments, its data with the data from the digital vacuum. The aggregated data is sent via the digital manifold's long-range radio (e.g., cellular) to a wireless communication device.

Further details on at least one embodiment of the described technology are provided in the documents appended herewith.

In general, the detailed description of embodiments of the described technology is not intended to be exhaustive or to limit the technology to the precise form disclosed above. While specific embodiments of, and examples for, the technology are described above for illustrative purposes, various equivalent modifications are possible within the scope of the described technology, as those skilled in the relevant art will recognize. For example, while processes, blocks, and or components are presented in a given order, alternative embodiments may perform routines having steps, or employ systems having blocks, in a different order, and some processes or blocks may be deleted, moved, added, subdivided, combined, and/or modified. Each of these processes, blocks, and or components may be implemented in a variety of different ways. Also, while processes, blocks, and or components are at times shown as being performed in series, these processes, blocks, and or components may instead be performed in parallel, or may be performed at different times.

The teachings of the described technology provided herein can be applied to other systems, not necessarily the system described herein. The elements and acts of the various embodiments described herein can be combined to provide further embodiments.

These and other changes can be made to the described technology in light of the above Detailed Description. While the above description details certain embodiments of the technology and describes the best mode contemplated, no matter how detailed the above appears in text, the described technology can be practiced in many ways. Details of the described technology may vary considerably in its implementation details, while still being encompassed by the technology disclosed herein. As noted above, particular terminology used when describing certain features or aspects of the described technology should not be taken to imply that the terminology is being redefined herein to be restricted to any specific characteristics, features, or aspects of the technology with which that terminology is associated. In general, the terms used in the following claims should not be construed to limit the described technology to the specific embodiments disclosed in the specification, unless the above Detailed Description section explicitly defines such terms. Accordingly, the actual scope of the described technology encompasses not only the disclosed embodiments, but also all equivalent ways of practicing or implementing the described technology.

I/we claim:

1. A computer-implemented method of wirelessly communicating HVAC data, comprising:
receiving data from a wireless component of a HVAC device;
storing the data in a data structure;
determining one or more measurements based on the data; and
displaying the one or more measurements at a wireless device.

2. The method of claim 1, wherein the HVAC device measures at least one of temperature or pressure.

3. The method of claim 1, wherein the method is performed by a smartphone.

4. The method of claim 1, further comprises wirelessly sending information to the HVAC device for configuring an operational characteristic of the HVAC device.

5. The method of claim 4, wherein the operational characteristic is for performing at least one of controlling power, updating reporting, calibrating sensors, setting timers, or executing programs at the HVAC device.

6. The method of claim 1, further comprising using the data to configure alarms, generate reporting and or billing information, measure fluid weight, or update a refrigerant table, and wherein the measurements are pressure or temperature measurements.

7. An HVAC system, comprising:
an HVAC device;
a CPU coupled to the HVAC device;
a wireless component couple to the HVAC device; and
one or more sensors.

8. The HVAC apparatus of claim 7, further comprising a strain gauge for converting analog pressure into a digital signal that is sent via the wireless component to a remote computing device.

9. The HVAC apparatus of claim 7, wherein a first sensor of the one or more sensors detects fluid temperature and a second sensor of the one or more sensors detects fluid pressure.

10. The HVAC apparatus of claim 7, wherein one or more of the sensors are pressure sensors, wherein a pressure measured by the one or more pressure sensors is converted into a representative digital signal that is sent via the wireless component for display at a remote computing device.

11. The HVAC apparatus of claim 7, wherein one or more of the sensors are temperature sensors, wherein a temperature measured by the one or more temperature sensors is converted into a representative digital signal that is sent via the wireless component for display at a remote computing device.

12. The HVAC apparatus of claim 7, wherein the wireless component is a short range wireless radio technology.

13. The HVAC apparatus of claim 12, wherein the short range wireless technology is a Bluetooth or a Wi-Fi technology.

14. The HVAC apparatus of claim 7, wherein the wireless component is a long range wireless radio technology.

15. The HVAC apparatus of claim 13, wherein the long-range range wireless technology is at least one of a cellular/3G/LTE, a satellite, or a WiMax technology.

16. A computer-implemented method for detecting an operation mode of a HVAC device, comprising:
operating a first HVAC device in a first mode when the first HVAC device does not detect availability of wireless communication access to a remote data collection device, wherein when the first HVAC device is operating in the first mode, data collected by the first HVAC device is configured for display at the first HVAC device; and
operating the first HVAC device in a second mode when the first HVAC device detects availability of wireless communication access to the remote data collection device, wherein when the first HVAC is operating in the second mode, data collected by the first HVAC device is wirelessly sent to the remote data collection device.

17. The computer-implemented method of claim 16, wherein the remote data collection device is a mobile device, and wherein the first HVAC device is a digital manifold or a digital vacuum gauge.

18. The computer-implemented method of claim 16, further comprising, operating the first HVAC device in a third mode when the first HVAC device detects availability of wireless communication access, via a long range communication technology, to a remote data collection device,
wherein when the first HVAC operates in the third mode, the first HVAC device is configured to receive HVAC data, via a short range communication technology, from a second HVAC device, and
wherein the first HVAC device sends to the remote data collection device, via the long range communication technology, at least a portion of the HVAC data received from the second HVAC.

19. The computer-implemented method of claim 18, wherein the first HVAC device is a digital vacuum gauge and the second HVAC device is digital manifold.

20. The computer-implemented method of claim 18, wherein the first HVAC device is a digital manifold and the second HVAC device is digital vacuum gauge.
